(19) United States
(12) Patent Application Publication
(10) Pub. No.: US 2017/0335548 A1
(43) Pub. Date: Nov. 23, 2017

(54) WORK VEHICLE

(71) Applicant: KOMATSU LTD., Tokyo (JP)

(72) Inventors: Takashi NODA, Hirakata-shi, Osaka (JP); Takuya UEMURA, Hirakata-shi, Osaka (JP); Masami HIRAYAMA, Hirakata-shi, Osaka (JP); Takashi TSUKAMOTO, Hirakata-shi, Osaka (JP); Akira KOTANI, Hirakata-shi, Osaka (JP); Taira OZAKI, Ikoma-shi, Nara (JP); Hayato KINOSHITA, Meguro-ku, Tokyo (JP)

(73) Assignee: KOMATSU LTD., Tokyo (JP)

(21) Appl. No.: 15/536,370

(22) PCT Filed: Feb. 16, 2016
(86) PCT No.: PCT/JP2016/054469

§ 371 Date: Jun. 15, 2017

(30) Foreign Application Priority Data
Feb. 23, 2015 (JP) 2015-033294
Oct. 23, 2015 (JP) 2015-208832

(51) Int. Cl. E02F 9/26; E02F 9/20; B60Q 1/24; B60Q 1/04; E02F 3/76; B60R 1/00; G05D 1/00; E02F 3/84

(52) U.S. Cl. CPC E02F 9/264; G05D 1/0038; E02F 9/205; E02F 3/844; B60Q 1/04; E02F 3/7609; B60R 1/00; B60Q 1/24; E02F 3/7604

(57) ABSTRACT

Lift cylinder is attached to a center part of a vehicle body in a vehicle width direction. The lift cylinder causes a work implement to move up and down. A supporting member is attached to the center part of the vehicle body in the vehicle width direction and extends upward from the vehicle body. An imaging device is supported by the supporting member and captures images of a region in front of the vehicle body. A penetrating part is formed in the supporting member. The lift cylinder is disposed through the penetrating part.

### CROSS-REFERENCE TO RELATED APPLICATIONS

This application is a U.S. National stage application of International Application No. PCT/JP2016/054469, filed on Feb. 16, 2016. This U.S. National stage application claims priority under 35 U.S.C. §119(a) to Japanese Patent Application No. 2015-033294, filed in Japan on Feb. 23, 2015 and to Japanese Patent Application No. 2015-208832, filed in Japan on Oct. 23, 2015, the entire contents of which are hereby incorporated herein by reference.

### BACKGROUND

### Field of the Invention

The present invention relates to a work vehicle.

### Description of the Related Art

A work vehicle includes an actuator for driving a work implement. For example, a pair of left and right lift cylinders are provided on both sides of a vehicle body for causing a work implement to move up and down (see Japanese Patent Laid-open No. 2007-077722).

### SUMMARY

However, when the work implement is used for carrying out work, such as excavating, the load applied to the work implement is transmitted to the vehicle body of the work vehicle through the lift cylinders. When the pair of lift cylinders are disposed away from each other to the left and right, different loads of different sizes may be applied to the vehicle body from each of the lift cylinders.

In order to improve the load balance, a lift cylinder may be disposed in the center of the work vehicle. However, in this case, it is difficult to recognize a region in front of the work vehicle due to the lift cylinder.

An object of the present invention is to provide a work vehicle in which it is possible to easily recognize the conditions of a region in front of the work vehicle and in which it is possible to improve the balance of the load applied to the vehicle body from the work implement.

A work vehicle according to a first aspect of the present invention includes a vehicle body, a work implement, a lift cylinder, an imaging device, and a supporting member. The work implement is disposed in front of the vehicle body. The lift cylinder is attached to a center part of a vehicle body in the vehicle width direction. The lift cylinder causes the work implement to move up and down. The supporting member is attached to the center part of the vehicle body in the vehicle width direction and extends upward from the vehicle body. The imaging device is supported by the supporting member and captures images of a region in front of the vehicle body. A penetrating part is formed in the supporting member. The lift cylinder is disposed through the penetrating part.

In the work vehicle according to the first aspect, images of the region in front of the vehicle body can be captured by the imaging device. As a result, the conditions of the region in front of the vehicle body can be easily recognized. Further, the lift cylinder is attached to the center part of a vehicle body in the vehicle width direction. As a result, the balance of the load applied to the vehicle body from the work implement can be improved in comparison to when a pair of lift cylinder are disposed away from each other to the left and right.

The operator of the work vehicle is able to recognize the conditions in front of the work vehicle due to the images captured by the imaging device. As a result, there is no problem with a decrease in forward visibility even when the lift cylinder and the supporting member are attached to the center part of the vehicle body in the vehicle width direction. Furthermore, the lift cylinder is disposed in the penetrating part of the supporting member. As a result, interference of the lift cylinder with regard to the supporting member is avoided and the supporting member and the lift cylinder can be disposed in a compact manner.

The vehicle body may have a mounting member. The lift cylinder may be attached to the mounting member. The supporting member may be attached to the mounting member. In this case, the supporting member and the lift cylinder can be disposed in a compact manner. Further, the supporting member can be firmly supported.

The vehicle body may have a universal joint for supporting the lift cylinder so as to allow rotational movement to the front and rear and to the left and right. The supporting member may be attached to the mounting member via the universal joint. In this case, the movements of the lift cylinder are absorbed by the universal joint. As a result, the load applied to the vehicle body from the lift cylinder can be reduced even further.

The supporting member may have a pillar part that extends upward from the vehicle body, and a holding part that extends toward the front from the pillar part. The imaging device may have a work implement imaging device supported by the holding part. In this case, the conditions in front of the work implement can be recognized easily due to the work implement imaging device capturing images of the region in front of the work implement.

A work vehicle according to a second aspect of the present invention includes a vehicle body, a work implement, a lift cylinder, an imaging device, and a supporting member. The work implement is disposed in the front of the vehicle body. The lift cylinder is attached to a center part of a vehicle body in the vehicle width direction. The lift cylinder causes the work implement to move up and down. The supporting member is attached to the center part of the vehicle body in the vehicle width direction and extends upward from the vehicle body. The imaging device is supported by the supporting member and captures images of a region in front of the vehicle body. A penetrating part is formed in the supporting member. The lift cylinder is disposed through the penetrating part.

The supporting member has a pillar part that extends upward from the vehicle body, and a first beam part that extends in the vehicle width direction form the pillar part. The penetrating part is formed by the pillar part and the first beam part. The lift cylinder is disposed through the penetrating part.

In the work vehicle according to the second aspect, images of the region in front of the vehicle body can be captured by the imaging device. As a result, the conditions of the region in front of the vehicle body can be easily recognized. Further, the lift cylinder is attached to the center part of the vehicle body in the vehicle width direction. As a result, the balance of the load applied to the vehicle body from the work implement can be improved in comparison to when a pair of lift cylinder are disposed away from each other to the left and right.

The operator of the work vehicle is able to recognize conditions in front of the work vehicle due to the images captured by the imaging device. As a result, there is no problem with a decrease in forward visibility even if the lift cylinder is attached to the center part of the vehicle body in the vehicle width direction. Furthermore, the lift cylinder is disposed in the penetrating part of the supporting member. As a result, interference of the lift cylinder on the supporting member is avoided.

The imaging device may have a work implement imaging device supported by the first beam part. In this case, the conditions in front of the work implement can be recognized easily due to the work implement imaging device capturing images of the region in front of the work implement.

The vehicle body in the work vehicle of either of the first aspect or the second aspect may have a mounting member. The lift cylinder may be attached to the mounting member. The supporting member may be attached to the mounting member in the work vehicle of the first aspect. In this case, the supporting member and the lift cylinder can be disposed in a compact manner. Further, the supporting member can be firmly supported.

The vehicle body in the work vehicle of either of the first aspect or the second aspect may have a universal joint for supporting the lift cylinder so as to allow rotational movement to the front and rear and to the left and right. The supporting member may be attached to the mounting member via the universal joint. In this case, the movements of the lift cylinder are absorbed by the universal joint. As a result, the load applied to the vehicle body from the lift cylinder can be reduced even further.

The front surface of the pillar part in the work vehicle of either of the first aspect or the second aspect may be inclined toward the front and upward from the vehicle body. In this case, the mobility range of the work implement disposed in front of the pillar part can be increased.

The holding part in the work vehicle of the first aspect may have a shape that is tapered toward the front. As a result, the load of the supporting member on an attachment part of the vehicle body can be reduced.

The work vehicle of the second aspect may further include a headlight supported by the first beam part. As a result, work efficiency can be improved at night or in dark areas.

The work vehicle of the second aspect may further include a rotating lamp. The supporting member may have a second beam part that extends from a right pillar part and a left pillar part to the inside in the vehicle width direction above the first beam part. The rotating lamp may be supported by the second beam part. As a result, the visibility of the rotating lamp is improved because the rotating lamp is disposed in a high position.

The upper end of the rotating lamp may be positioned higher than the upper end of the lift cylinder. As a result, the visibility of the rotating lamp is improved because the rotating lamp is not shielded by the lift cylinder.

The vehicle body in the work vehicle of either of the first aspect or the second aspect may have a universal joint and a mounting member. The universal joint supports the lift cylinder so as to allow rotational movement to the front and rear and to the left and right. The mounting member has the lift cylinder attached thereto via the universal joint. In this case, the movements of the lift cylinder are absorbed by the universal joint. As a result, the load applied to the vehicle body from the lift cylinder can be reduced even further.

The imaging device in either of the work vehicle of the first aspect or the second aspect may have a front imaging device disposed in front of the lift cylinder. In this case, the conditions of the region in front of the lift cylinder can be recognized easily.

The lift cylinder may overlap the supporting member as seen in a side view of the vehicle in the either of the work vehicle of the first aspect or the second aspect. In this case, the supporting member and the lift cylinder can be disposed in a compact manner.

The work vehicle may further include a communication device and a controller in the work vehicle of either of the first aspect or the second aspect. The communication device communicates with an external remote operating device. The communication device transmits image data captured by the imaging device to the remote operating device. The communication device receives operation signals for operating the work vehicle from the remote operating device. The controller controls the work vehicle on the basis of the operation signals from the remote operating device.

In this case, the operator of the work vehicle is able to remotely operate the work vehicle with the remote operating device while viewing the images captured by the imaging device.

According to the present invention, a work vehicle can be provided in which it is possible to easily recognize conditions of a region in front of the work vehicle and in which it is possible to improve the balance of the load applied to the vehicle body from the work implement.

### BRIEF DESCRIPTION OF DRAWINGS

FIG. 1 is a perspective view of a work vehicle according to a first exemplary embodiment.

FIG. 2 is a side view of the work vehicle according to the first exemplary embodiment.

FIG. 3 is a plan view of the work vehicle according to the first exemplary embodiment.

FIG. 4 is a block diagram illustrating a control system of the work vehicle.

FIG. 5 is a block diagram illustrating a configuration and a processing flow for generating a display image.

FIG. 6 is a rear perspective view of a supporting member according to the first exemplary embodiment.

FIG. 7 is a front perspective view of the supporting member according to the first exemplary embodiment.

FIG. 8 is a front perspective view illustrating the structure in the vicinity of the supporting member and the lift cylinder according to the first exemplary embodiment.

FIG. 9 is a rear perspective view illustrating the structure in the vicinity of the supporting member and the lift cylinder according to the first exemplary embodiment.

FIG. 10 is a cross-sectional view of the supporting member and the lift cylinder according to the first exemplary embodiment.

FIG. 11 is a perspective view of a joint body.

FIG. 12 is a perspective view illustrating actual conditions of the work vehicle.

FIGS. 13A-13D illustrate examples of images captured by a surroundings imaging device mounted on the work vehicle illustrated in FIG. 4.

FIG. 14 illustrates an example of a surroundings composite image.

FIG. 15 illustrates an example of an image at the front of a work implement.

FIG. 16 is a perspective view illustrating actual conditions of the work vehicle.

FIG. 17 illustrates processing for generating a work implement composite image.

FIG. 18 illustrates an example of a display image.

FIG. 19 is a perspective view of the work vehicle according to a second exemplary embodiment.

FIG. 20 is a side view of the work vehicle according to the second exemplary embodiment.

FIG. 21 is a plan view of the work vehicle according to the second exemplary embodiment.

FIG. 22 is an enlarged perspective view in the vicinity of the upper end of the supporting member according to the second exemplary embodiment.

FIG. 23 is a side view of the work vehicle according to a first modified example.

FIG. 24 is a side view of the work vehicle according to a second modified example.

### DESCRIPTION OF EXEMPLARY EMBODIMENTS

### First Exemplary Embodiment

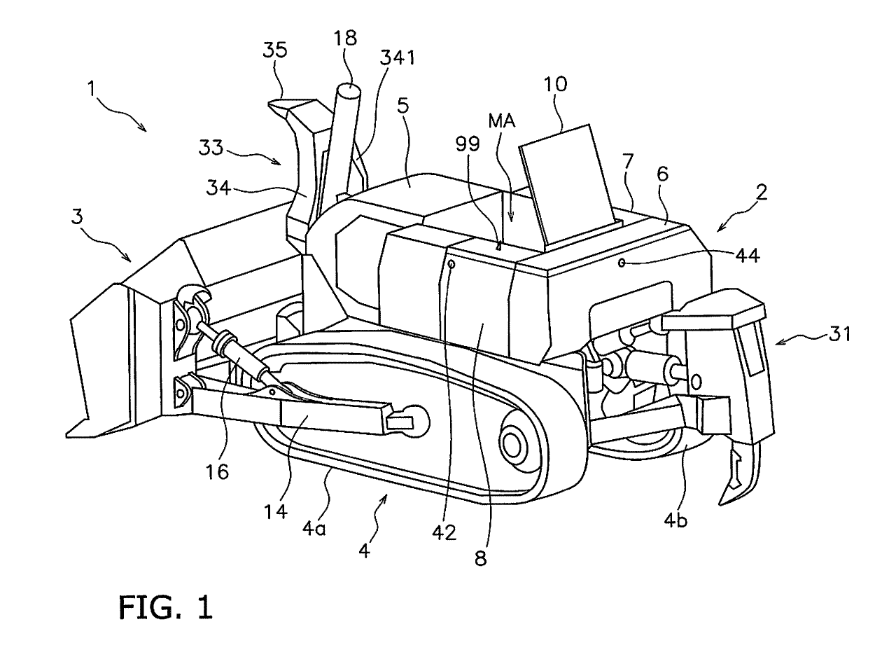

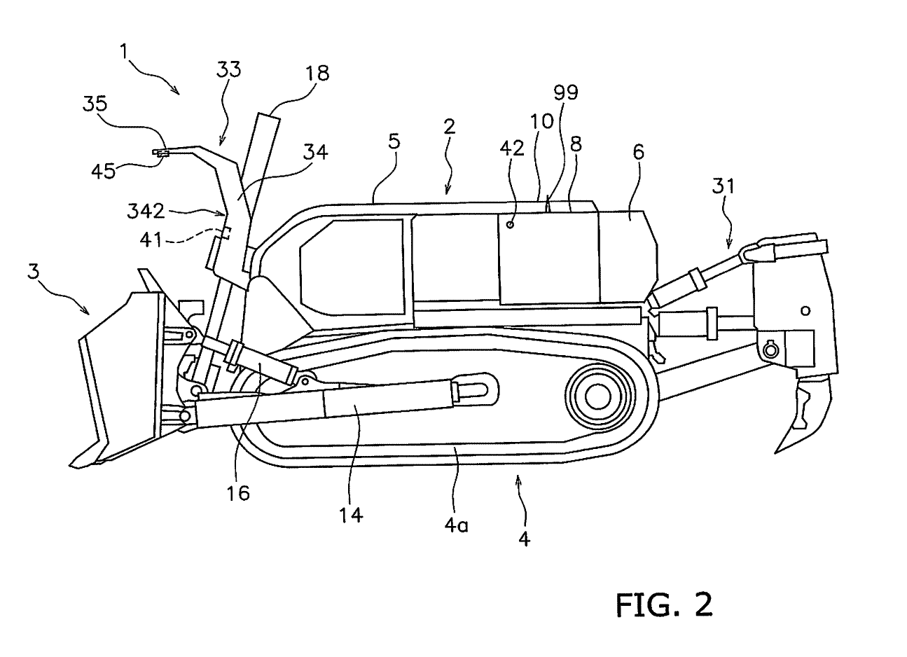

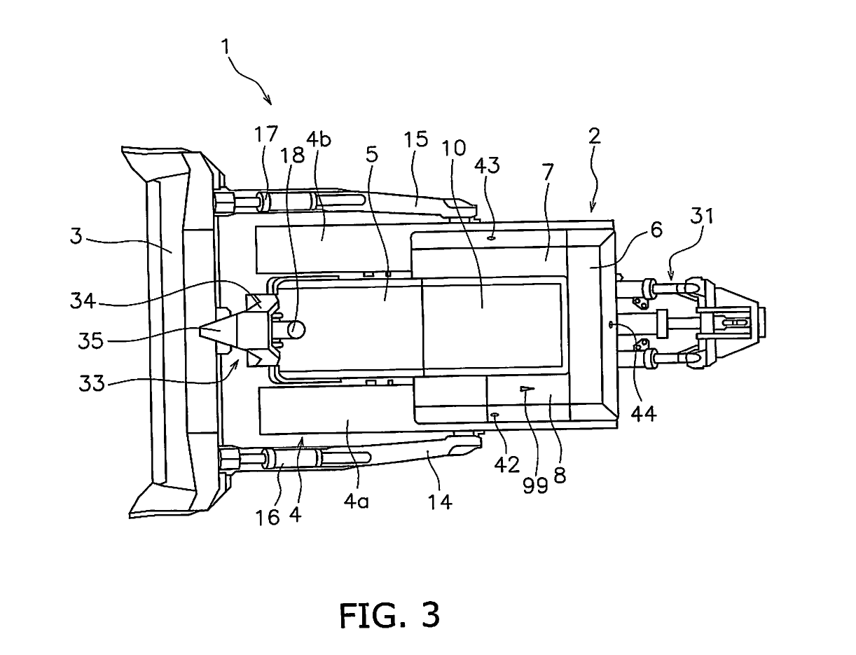

The following is a description of a work vehicle according to the present exemplary embodiment with reference to the drawings. FIG. 1 is a perspective view of a work vehicle 1 according to the first exemplary embodiment. FIG. 2 is a side view of the work vehicle 1 according to the present exemplary embodiment. FIG. 3 is a plan view of the work vehicle 1 according to the present exemplary embodiment. The work vehicle 1 is a bulldozer according to the present exemplary embodiment. The work vehicle 1 is a vehicle that is not provided with an operator's cab. As discussed below, the work vehicle 1 can be operated remotely. The work vehicle 1 includes a vehicle body 2 and a work implement 3.

The vehicle body 2 has a travel device 4 and an engine compartment 5. The travel device 4 is a device for causing the work vehicle 1 to travel. The travel device 4 has crawler belts 4a and 4b. The crawler belt 4a is mounted on the left side part of the vehicle body 2. The crawler belt 4b is mounted on the right side part of the vehicle body 2. The work vehicle 1 travels due to the crawler belts 4a and 4b being driven.

The front signifies the direction in which the lift cylinder is disposed on the vehicle body 2 in the present exemplary embodiment, and the rear signifies the opposite direction. Left and right signify the left and right directions when facing the above-mentioned direction toward the front.

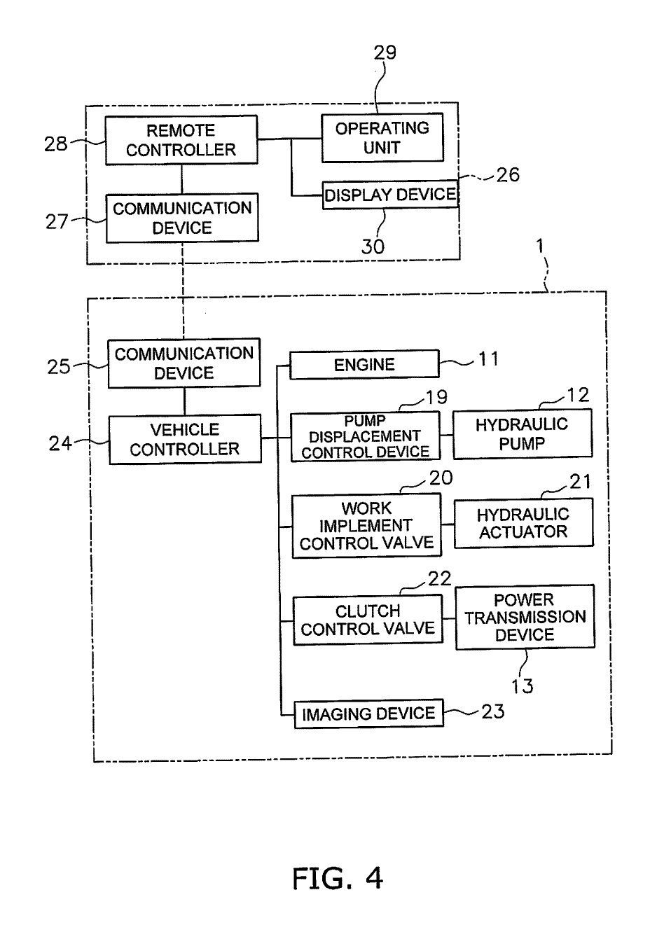

The engine compartment 5 is disposed on a front part of the vehicle body 2. An engine 11 (see FIG. 4) is disposed inside the engine compartment 5.

The vehicle body has a rear compartment 6, a right compartment 7, and a left compartment 8. The engine compartment 5, the rear compartment 6, the right compartment 7, and the left compartment 8 are disposed so as to surround a maintenance area MA. The engine compartment 5 is disposed in front of the maintenance area MA. The rear compartment 6 is disposed behind the maintenance area MA. The right compartment 7 is disposed to the right of the maintenance area MA. The left compartment 8 is disposed to the left of the maintenance area MA.

For example, the rear compartment 6 is a fuel tank. The rear compartment 6 may be configured to house the fuel tank. A cooling device, such as a radiator, is disposed in the right compartment 7. A hydraulic fluid tank is disposed in the left compartment 8. However, the items housed in the compartments 6-8 are not limited to the above items and may be changed.

A lid member 10 is disposed above the maintenance area MA. The lid member 10 is disposed so as to be able to open and close the maintenance area MA. The lid member 10 is depicted while open in FIG. 1 and the lid member 10 is depicted while closed in FIGS. 2 and 3.

Doors (not illustrated) for opening and closing the engine compartment and the right compartment 7 are provided facing the maintenance area MA on the engine compartment 5 and on the right compartment 7. A worker is able to access the inside of the engine compartment 5 or the inside of the right compartment 7 from the maintenance area MA by opening the door on the engine compartment 5 or on the right storing part 7.

The work implement 3 is disposed in front of the vehicle body 2. The work implement 3 is disposed in front of the engine compartment 5. In the present exemplary embodiment, the work implement 3 is a blade. The work implement 3 is supported by a left arm 14 and a right arm 15. The left arm 14 is mounted on a left side part of the vehicle body 2. The right arm 15 is mounted on a right side part of the vehicle body 2.

A left tilt cylinder 16, a right tilt cylinder 17, and a lift cylinder 18 are attached to the work implement 3. The left tilt cylinder 16 is attached to the left side part of the vehicle body 2. The right tilt cylinder 17 is attached to the right side part of the vehicle body 2. The left tilt cylinder 16 and the right tilt cylinder 17 are driven by hydraulic fluid from a hydraulic pump 12. The left tilt cylinder 16 and the right tilt cylinder 17 cause the work implement 3 to move to the left or right.

The lift cylinder 18 is attached to the center part of the vehicle body 2 in the vehicle width direction. The lift cylinder 18 is attached to the vehicle body 2 while being inclined in the front-back direction of the vehicle body 2. Only one lift cylinder 18 is provided in the work vehicle 1. The lift cylinder 18 is disposed in front of the engine compartment 5. The lift cylinder 18 is disposed behind the work implement 3. The lift cylinder 18 is driven by hydraulic fluid from the hydraulic pump 12. The lift cylinder 18 causes the work implement 3 to move up and down.

The work vehicle 1 includes a ripper device 31. The ripper device 31 is disposed behind the vehicle body 2. The ripper device 31 is attached to the vehicle body 2. The ripper device may be omitted.

FIG. 4 is a block diagram of a control system of the work vehicle 1. As illustrated in FIG. 4, the work vehicle 1 has the hydraulic pump 12 and a pump displacement controller 19. The hydraulic pump 12 is driven by the engine 11 to discharge hydraulic fluid. The hydraulic pump 12 is a variable displacement pump and the pump displacement controller 19 controls the discharge displacement of the hydraulic pump 12.

The work vehicle 1 has a work implement control valve 20 and a hydraulic actuator 21. The hydraulic actuator 21 is driven by hydraulic fluid discharged from the hydraulic pump 12. For example, the hydraulic actuator 21 includes the above-mentioned lift cylinder 18 and the left and right tilt cylinders 16 and 17. The work implement control valve 20 controls the supply and exhaust of the hydraulic fluid to and from the hydraulic actuator 21.

The work vehicle 1 has a power transmission device 13 and a clutch control valve 22. The power transmission device 13 includes, for example, a transmission and a torque converter. The clutch control valve 22 controls the switching of a speed change clutch, a forward/reverse travel clutch, and a steering clutch and the like included in the power transmission device 13.

The work vehicle 1 has an imaging device 23. The imaging device 23 acquires images of the surroundings of the work vehicle 1. The imaging device is described in detail below.

The work vehicle 1 includes a vehicle controller 24 and a communication device 25. The communication device 25 is connected to an antenna 99 (see FIG. 1) mounted on the vehicle body 2. The communication device 25 carries out wireless communication with a communication device 27 of a remote operating device 26. For example, the remote operating device 26 is disposed inside a management center away from the work site where the work vehicle 1 is used. Alternatively, the remote operating device 26 may be portable and may be disposed at the work site.

The vehicle controller 24 is configured with a computation device, such as a CPU, and a memory, such as a RAM or a ROM, or with a storage device, such as a hard disk. The vehicle controller 24 is programmed to control the work vehicle 1 on the basis of operation signals from the remote operating device 26. Moreover, the vehicle controller 24 acquires image data acquired by the imaging device 23 through a wire or wirelessly. The vehicle controller 24 transmits the image data captured by the imaging device 23 to the communication device 27 of the remote operating device 26 via the communication device 25.

The remote operating device 26 has a remote controller 28 and an operating unit 29. The remote controller 28 is configured with a computation device, such as a CPU, and a memory such, as a RAM or a ROM, or with a storage device, such as a hard disk.

The operating member 29 is operated by an operator for operating the work vehicle 1. For example, the operating unit 29 includes an acceleration operating device for adjusting the output of the engine 11. The operating unit 29 includes a work implement operating device for operating the work implement 3. The operating unit 29 includes a steering operating device for changing the traveling direction of the work vehicle 1 to the right and left. The remote controller 28 transmits operation signals indicating the operating contents from the operating unit 29 to the communication device 25 of the work vehicle 1 via the communication device 27.

The remote operating device 26 has a display device 30. The display device 30 is configured with a display, such as a CRT, an LCD, an OELD, or the like. However, the display device 30 is not limited to the afore-mentioned displays and may be another type of display.

The communication device 27 of the remote operating device 26 receives the image data captured by the imaging device 23 from the communication device 25 of the work vehicle 1. The remote controller 28 is programmed to generate a display image indicating the surroundings of the work vehicle 1 and display the display image on the display device 30 on the basis of the image data captured by the imaging device 23.

The operator operates the operating unit 29 while viewing the display image. As a result, the operation signals are transmitted from the communication device 27 of the remote operating device 26 and the communication device 25 of the work vehicle 1 receives the operation signals from the remote operating device 26. The vehicle controller 24 controls the above-mentioned engine 11, the pump displacement controller 19, the work implement control valve 20, and the clutch control valve 22 and the like on the basis of the operation signals. As a result, the operator is able to operate the work vehicle 1 remotely.

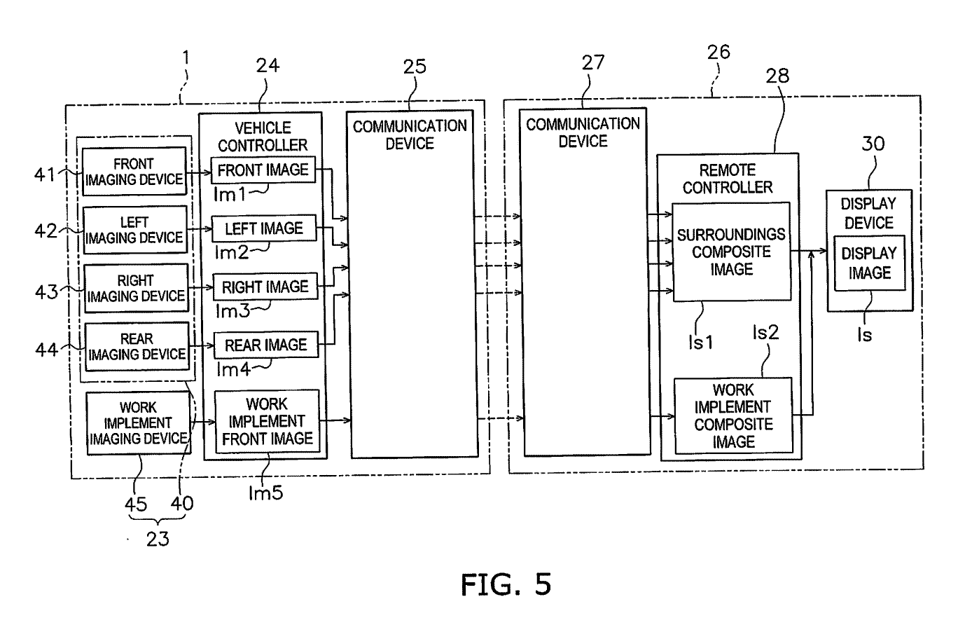

Next, a configuration and processing for generating the display image will be explained in detail. FIG. 5 is a block diagram illustrating a configuration and a processing flow for generating the display image. As illustrated in FIG. 5, the imaging device 23 mounted on the work vehicle 1 has a surroundings imaging device 40 and a work implement imaging device 45. The surroundings imaging device 40 captures images of the surroundings of the vehicle body 2. That is, the surroundings imaging device 40 captures images of the regions in the front and back and left and right of the vehicle body 2. The work implement imaging device 45 captures images of the region in front of the work implement 3 and of the work implement 3.

Specifically, the surroundings imaging device 40 includes a front imaging device 41, a left imaging device 42, a right imaging device 43, and a rear imaging device 44. A camera mounted with a fish-eye lens, for example, may be used as the front imaging device 41, the left imaging device 42, the right imaging device 43, and the rear imaging device 44. As illustrated in FIG. 2, the front imaging device 41 is attached to the supporting member 33. The front imaging device 41 is disposed in front of the lift cylinder 18. The front imaging device 41 captures images in front of the vehicle body 2. The left imaging device 42 is attached to a left side part of the vehicle body 2. The left imaging device 42 captures images to the left of the vehicle body 2. As illustrated in FIG. 3, the right imaging device 43 is attached to a right side part of the vehicle body 2. The right imaging device 43 captures images to the right of the vehicle body 2. The rear imaging device 44 is attached to a rear part of the vehicle body 2. The rear imaging device 44 captures images behind the vehicle body 2.

The work implement imaging device 45 is a camera including a lens with a normal angle of view. The work implement imaging device 45 is disposed above the work implement 3. Specifically, the work implement imaging device 45 is disposed higher than the upper end of the work implement 3. The work implement imaging device 45 is disposed higher than the front imaging device 41. The work implement imaging device 45 is disposed forward of the front imaging device 41. The work implement imaging device 45 is supported by the supporting member 33.

The front imaging device 41 and the work implement imaging device 45 are attached to the supporting member 33. The supporting member 33 is attached to a front part of the vehicle body 2. The supporting member 33 is attached to a center part of the vehicle body 2 in the vehicle width direction. The supporting member 33 is formed with a bent metal plate. The supporting member 33 has a pillar part 34 and a holding part 35.

The pillar part 34 extends upward from the vehicle body 2. The pillar part 34 has a shape that is tapered upward. The pillar part 34 is disposed in front of the engine compartment 5. The pillar part 34 is disposed behind the work implement 3. The front imaging device 41 is attached to the pillar part 34. The front imaging device 41 is attached to the front surface of the pillar part 34.

The holding part 35 extends toward the front from the pillar part 34. The holding part 35 is positioned above the work implement 3. The holding part 35 has a shape that is tapered toward the front. The holding part 35 supports the work implement imaging device 45. The work implement imaging device 45 is attached to the tip end part of the holding part 35. Specifically, the work implement imaging device 45 is attached to the lower surface of the tip end part of the holding part 35.

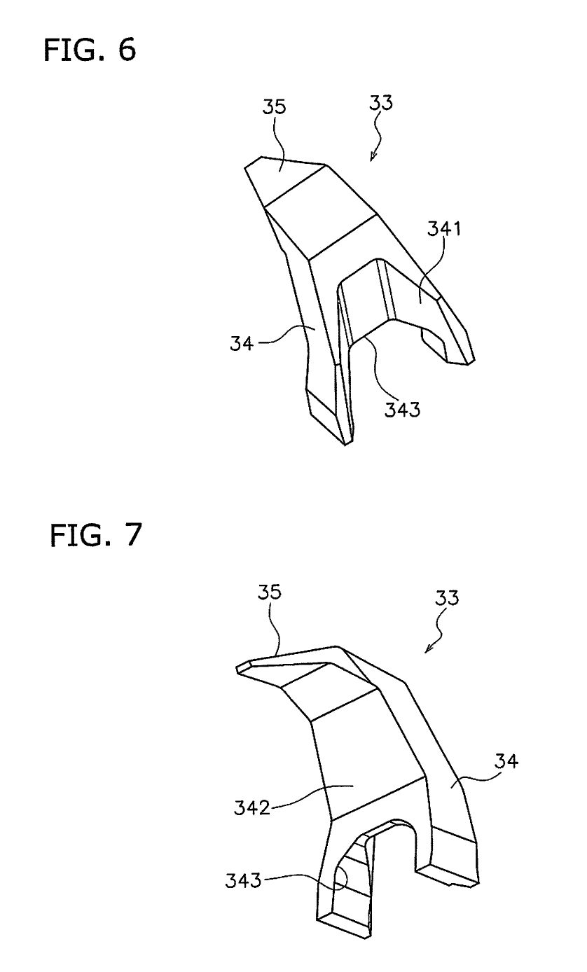

FIGS. 6 and 7 are perspective views of the supporting member 33. As illustrated in FIG. 6, a penetrating part 341 is formed on the back surface of the pillar part 34. The penetrating part 341 has a shape that is recessed toward the front. The penetrating part 341 extends in the up-down direction and penetrates the supporting member 33 in the up-down direction.

As illustrated in FIG. 2, a front surface 342 of the pillar part 34 is inclined toward the front and upward from the vehicle body 2. A recessed part 343 is formed on the lower part of the front surface 342 of the pillar part 34. The recessed part 343 has a shape that is recessed upward. The penetrating part 341 communicates with the recessed part 343.

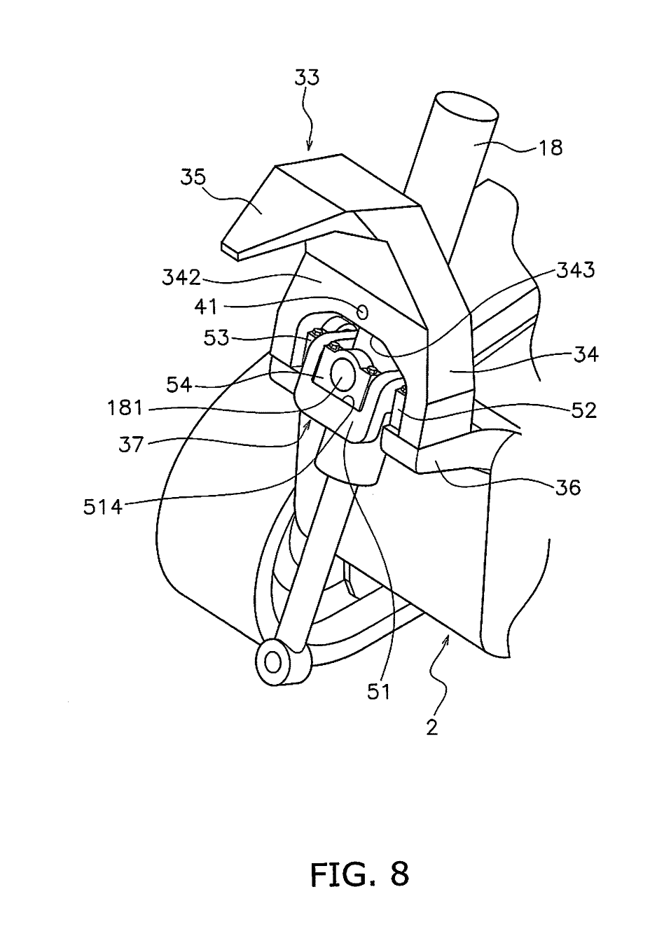

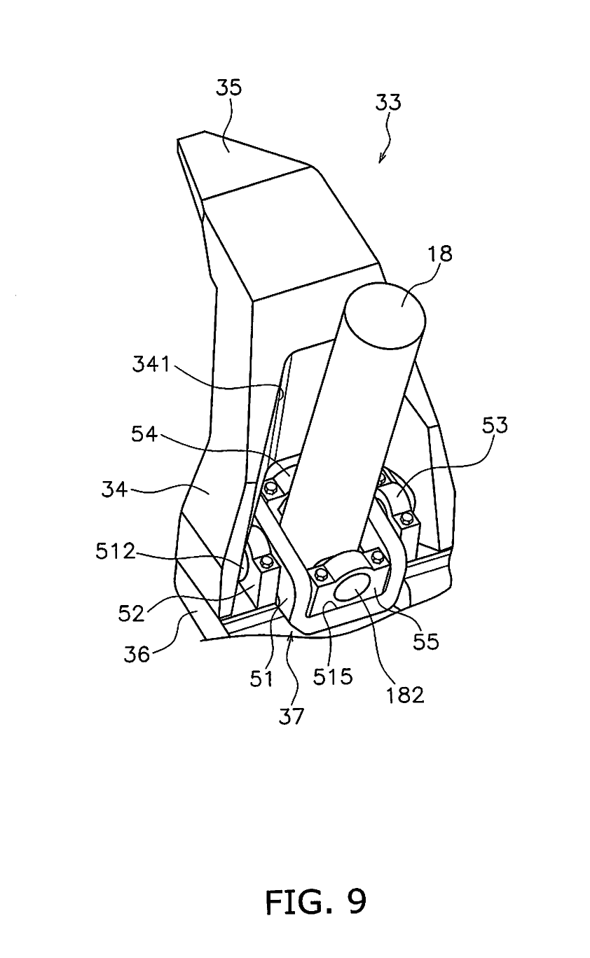

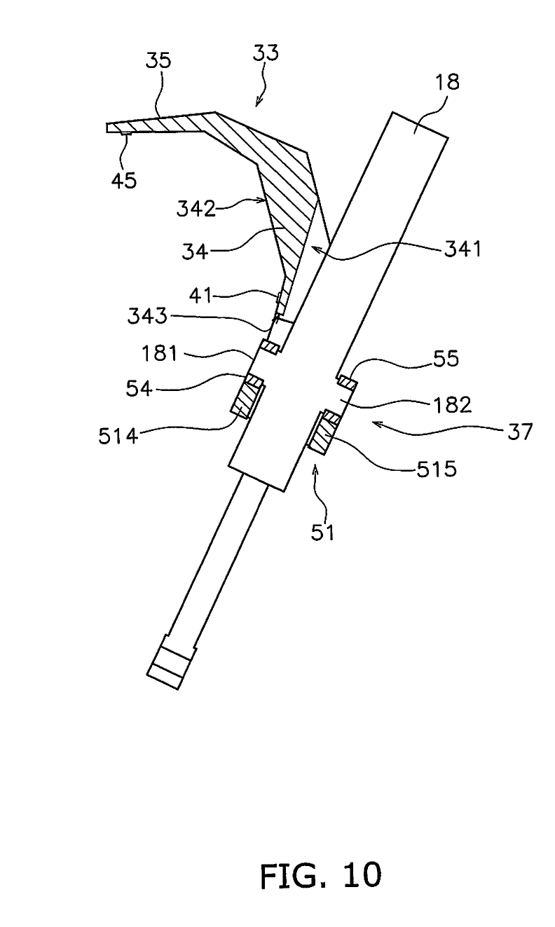

FIGS. 8 and 9 are perspective views of the supporting member 33 and the lift cylinder 18. FIG. 10 is a cross-sectional view of the supporting member 33. As illustrated in FIGS. 9 and 10, the lift cylinder 18 is disposed in the penetrating part 341. As a result, the lift cylinder 18 overlaps the pillar part 34 as seen in a side view of the vehicle as illustrated in FIG. 2. The lift cylinder 18 passes through the penetrating part 341 and protrudes upward from the supporting member 33. The lift cylinder 18 passes through the penetrating part 341 and protrudes downward from the supporting member 33.

As illustrated in FIGS. 8 and 10, the vehicle body 2 has a mounting member 36 and a universal joint 37. The mounting member 36 is disposed in front of the engine compartment 5. The mounting member 36 is coupled to a vehicle body frame that is not illustrated inside the vehicle body 2. The mounting member 36 has the lift cylinder 18 attached thereto via the universal joint 37. The pillar part 34 of the supporting member 33 is attached to the mounting member 36. The pillar part 34 is disposed on the mounting member 36. A bottom part of the pillar part 34 is attached to the mounting member 36.

The universal joint 37 supports the lift cylinder 18 so as to allow rotational movement to the front and rear and to the left and right. The universal joint 37 is disposed in the recessed part 343. The universal joint 37 has a joint body 51, a left shaft bearing part 52, a right shaft bearing part 53, a front shaft bearing part 54, and a rear shaft bearing part 55.

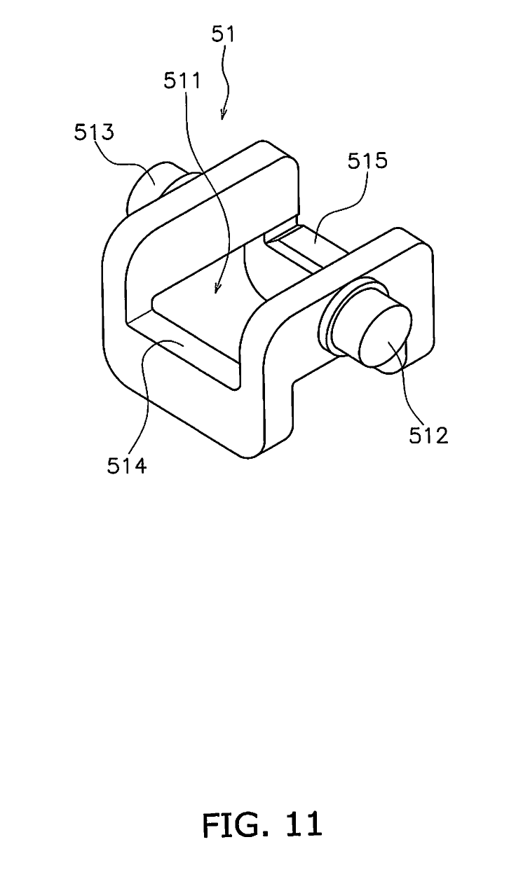

FIG. 11 is a perspective view of the joint body 51. As illustrated in FIG. 11, the joint body 51 has an opening 511. The opening 511 penetrates the joint body 51 in the up-down direction. The lift cylinder 18 passes through the opening 511. The joint body 51 has a left rotating shaft part 512 and a right rotating shaft part 513. The left rotating shaft part 512 and the right rotating shaft part 513 are disposed with a gap therebetween in the vehicle width direction. The opening 511 is disposed between the left rotating shaft part 512 and the right rotating shaft part 513. The left rotating shaft part 512 and the right rotating shaft part 513 extend in the vehicle width direction. The left rotating shaft part 512 is supported in a manner that allows rotation on the left shaft bearing part 52. The right rotating shaft part 513 is supported in a manner that allows rotation on the right shaft bearing part 53. As a result, the lift cylinder 18 is supported by the universal joint 37 so as to allow rotational movement to the front and rear.

The joint body 51 has a front attachment part 514 and a rear attachment part 515. The front attachment part 514 and the rear attachment part 515 are disposed so as to have a gap therebetween in the front-back direction. The opening 511 is disposed between the front attachment part 514 and the rear attachment part 515. The front shaft bearing part 54 is attached to the front attachment part 514. As illustrated in FIGS. 8 and 10, the front shaft bearing part 54 supports, in a manner that allows rotation, a front rotating shaft part 181 provided on the lift cylinder 18. The front rotating shaft part 181 protrudes toward the front from the lift cylinder 18. The rear shaft bearing part 55 is attached to the rear attachment part 515. As illustrated in FIGS. 9 and 10, the rear shaft bearing part 55 supports, in a manner that allows rotation, a rear rotating shaft part 182 provided on the lift cylinder 18. The rear rotating shaft part 182 protrudes toward the rear from the lift cylinder 18. As a result, the lift cylinder 18 is supported by the universal joint 37 so as to allow rotational movement to the right and left.

Next, a processing for generating the display image will be explained in detail. First, image capturing is carried out by the imaging devices 41-45. The vehicle controller 24 acquires image data of the surroundings of the vehicle body 2 from the surroundings imaging device 40. That is, as illustrated in FIG. 5, the vehicle controller 24 acquires a front image Im1, a left image Im2, a right image Im3, and a rear image Im4, respectively, from the front imaging device 41, the left imaging device 42, the right imaging device 43, and the rear imaging device 44.

The front image Im1 is an image toward the front of the vehicle body 2. The left image Im2 is an image in the leftward direction of the vehicle body 2. The right image Im3 is an image in the rightward direction of the vehicle body 2. The rear image Im4 is an image toward the rear of the vehicle body 2.

Moreover, the vehicle controller 24 acquires image data of the region in front of the work implement 3 from the work implement imaging device 45. That is, the vehicle controller 24 acquires a work implement front image Im5 from the work implement imaging device 45. The work implement front image Im5 is an image toward the front of the work implement 3 including the work implement 3.

The vehicle controller 24 sends the front image Im1, the left image Im2, the right image Im3, the rear image Im4, and the work implement front image Im5 to the remote controller 28 via the communication device 25.

The remote controller 28 generates a surroundings composite image Is1 from the images Im1 to Im4 captured by the surroundings imaging device 40. The surroundings composite image Is1 is an image depicting the surroundings of the work vehicle 1 from a bird's eye view, and is synthesized with a vehicle model M1 (FIG. 14). The vehicle model M1 is a model indicating the shape of the work vehicle 1.

The remote controller 28 generates a work implement composite image Is2 from the work implement front image Im5 captured by the work implement imaging device 45. The work implement composite image Is2 is an image indicating an area to the front of the work implement 3, and is synthesized with the vehicle model M1 and the surroundings composite image Is1.

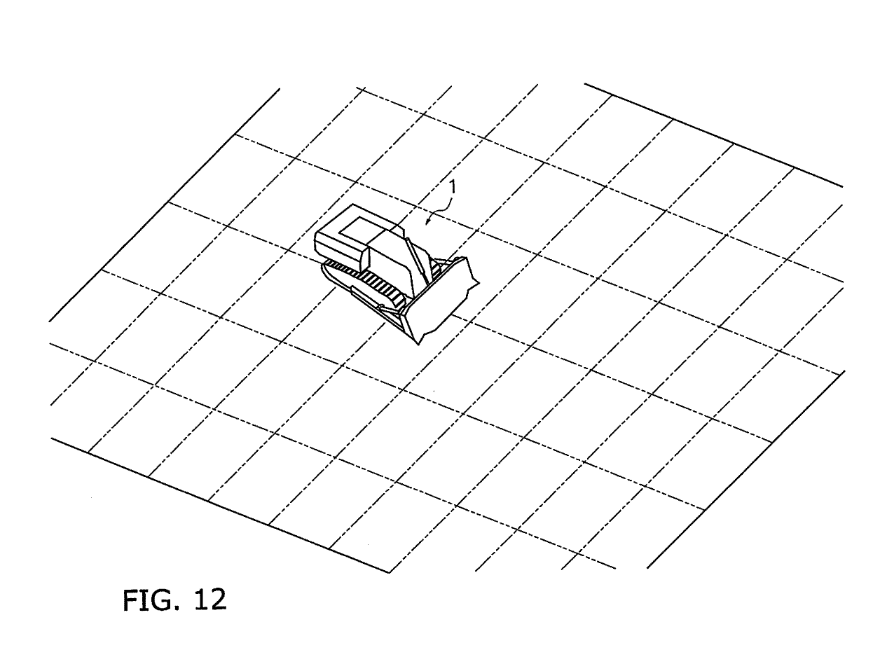

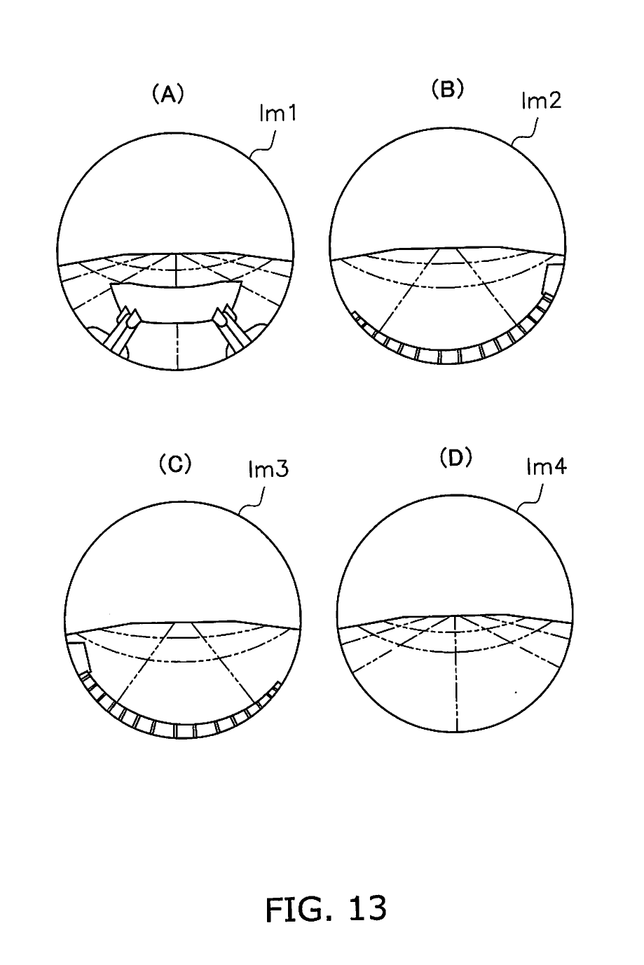

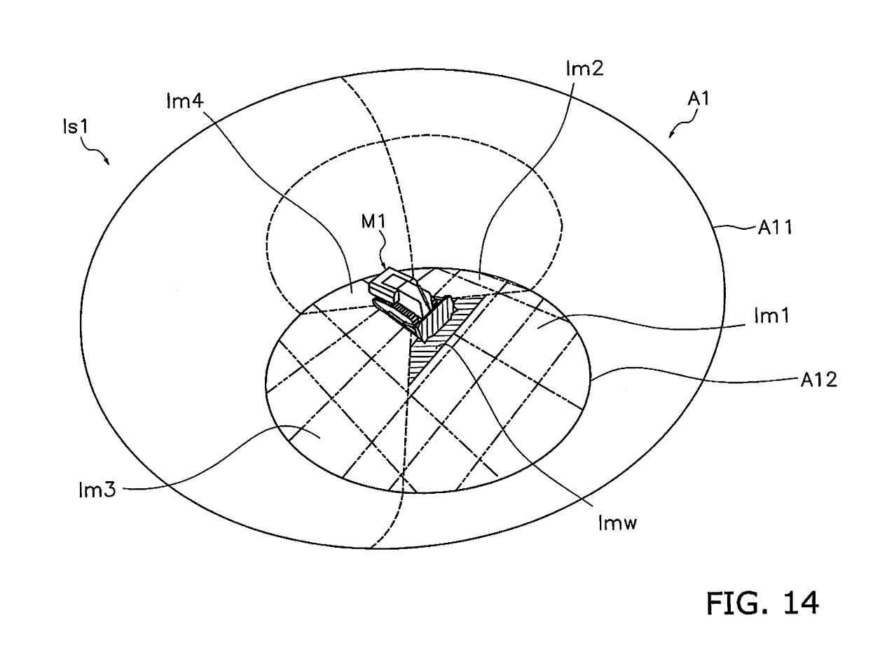

FIG. 12 is a perspective view illustrating actual conditions of the work vehicle 1. FIG. 13 illustrates examples of images captured by the surroundings imaging device 40 mounted on the work vehicle 1 in the state depicted in FIG. 12. Specifically, FIG. 13A is the front image Im1 captured by the front imaging device 41. FIG. 13B is the left image Im2 captured by the left imaging device 42. FIG. 13C is the right image Im3 captured by the right imaging device 43. FIG. 13D is the rear image Im4 captured by the rear imaging device 44.

As illustrated in FIG. 14, the remote controller 28 generates the surroundings composite image Is1 by projecting the images captured by the surroundings imaging device 40 onto a first projection plane A1. FIG. 14 illustrates an example of the surroundings composite image Is1 generated by the remote controller 28.

The first projection plane A1 has a hemispherical curved surface A11 that encloses the vehicle model M1, and a flat surface A12 corresponding to the ground surface. The vehicle model M1 is disposed on the flat surface A12. Although not illustrated in the drawings, the first projection plane A1 has a mesh structure and the remote controller 28 generates the surroundings composite image Is1 by projecting the images captured by the surroundings imaging device 40 onto the first projection plane A1 by texture mapping.

As illustrated in FIG. 14, the front image Im1, the left image Im2, the right image Im3, and the rear image Im4 are projected onto the first projection plane A1 and synthesized as the surroundings composite image Is1 of the vehicle model M1. However, because an image of the rear part of the work implement 3 (see FIG. 13(A)) is photographed in the front image Im1, the portion in front of the work implement 3 including the front surface of the work implement 3 becomes a blind spot. As a result, an image Imw (diagonal line hatched portion in FIG. 14) in front of the work implement 3 is omitted or not displayed accurately in the surroundings composite image Is1 as illustrated in FIG. 14.

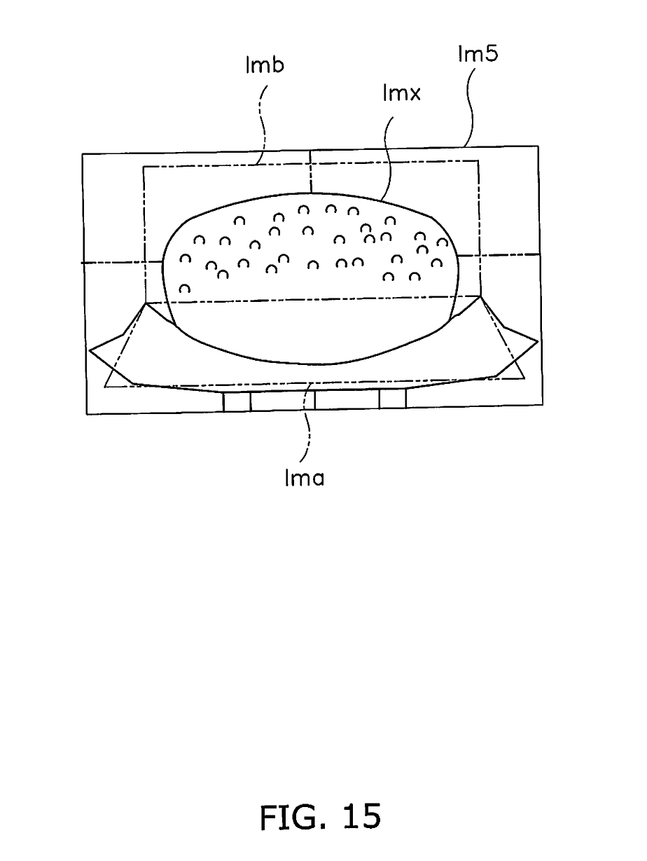

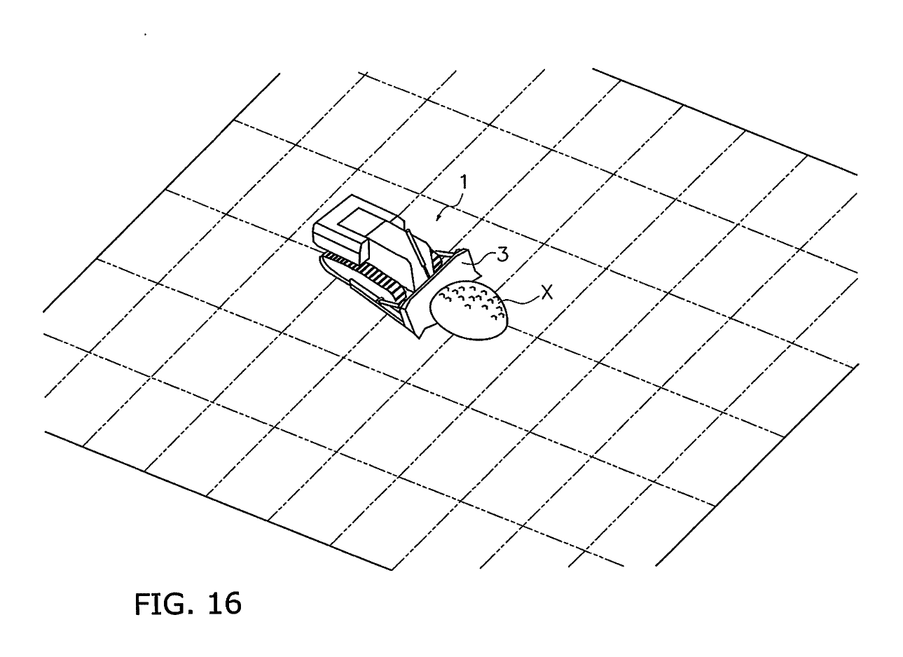

FIG. 15 illustrates an example of the work implement front image Im5 captured by the work implement imaging device 45. As illustrated in FIG. 15, the work implement front image Im5 includes an image Ima depicting the front surface of the work implement 3, and an image Imb depicting the ground surface located in front of the work implement 3. When the actual work vehicle 1 is carrying a work object X, such as sand and dirt as illustrated in FIG. 16, an image Imx depicting the work object X as illustrated in FIG. 15 is included in the work implement front image Im5.

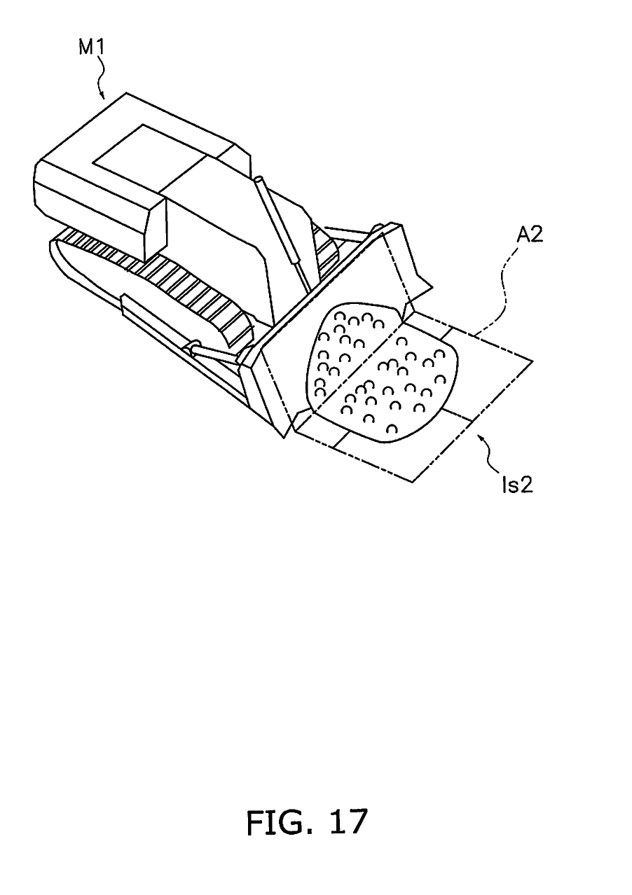

The remote controller 28 generates the work implement composite image Is2 by projecting the work implement front image Im5 captured by the work implement imaging device 45 onto a second projection plane A2 as illustrated in FIG. 17. The second projection plane A2 is disposed in the front surface of the work implement 3 of the vehicle model M1 and on the ground surface located in front of the work implement 3 of the vehicle model M1.

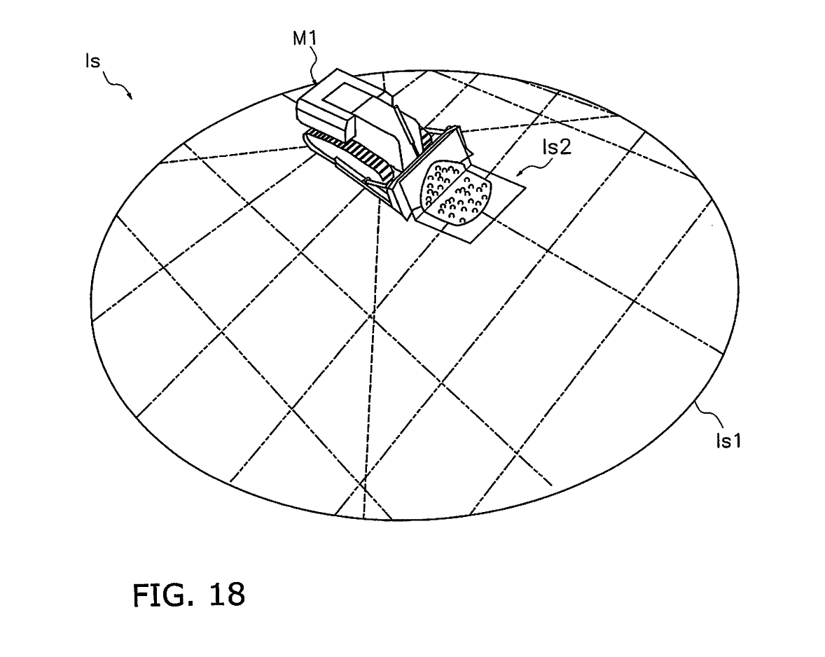

The display device 30 displays a display image Is. FIG. 18 illustrates an example of the display image Is. As illustrated in FIG. 18, the display image Is displays the work vehicle 1 and the surroundings thereof in a three-dimensional manner as seen diagonally from in front and from above. The display image Is includes the vehicle model M1, the surroundings composite image Is1, and the work implement composite image Is2 generated as described above. Specifically, the condition of the surroundings of the work vehicle 1 captured by the surroundings imaging device 40 is displayed as the surroundings composite image Is1 of the surroundings of the vehicle model M1 in the display image Is. Further, the condition of the front of the work implement 3 captured by the work implement imaging device 45 is displayed on the front surface of the work implement 3 of the vehicle model M1 and on the ground surface therebelow as the work implement composite image Is2. The display image Is is updated in real time and displayed as a video.

The conditions of the surroundings of the work vehicle 1 can be easily recognized by the display image Is in the work vehicle 1 according to the first exemplary embodiment as explained above. In particular, the region in front of the work implement 3 that becomes a blind spot when only using the surroundings imaging device 40 can be captured by the work implement imaging device 45 attached to the holding part 35 of the supporting member 33. As a result, the condition of the region in front of the work implement 3 can be easily recognized.

The lift cylinder 18 is attached to the center part of the vehicle body 2 in the vehicle width direction. As a result, the load from torsion transmitted from the work implement 3 to the vehicle body 2 can be reduced in comparison to when a pair of lift cylinders are disposed away from each other to the left and right.

The operator of the work vehicle 1 is able to recognize the conditions in front of the work implement 3 due to the display image Is. As a result, there is no problem with a decrease in forward visibility even if the lift cylinder 18 is attached to the center part of the vehicle body 2 in the vehicle width direction.

Furthermore, the lift cylinder 18 is disposed in the penetrating part 341 of the supporting member 33. As a result, interference of the lift cylinder 18 with regard to the supporting member 33 is avoided and the supporting member 33 and the lift cylinder 18 can be disposed in a compact manner.

The pillar part 34 is attached to the mounting member 36. Further, the supporting member 33 can be firmly supported. Moreover, the supporting member 33 and the lift cylinder 18 can be disposed in a compact manner. In particular, the lift cylinder 18 is disposed in the penetrating part 341 of the pillar part 34 and the pillar part 34 and the lift cylinder 18 overlap as seen in a side view of the vehicle. As a result, the supporting member 33 and the lift cylinder 18 can be disposed in a compact manner.

The lift cylinder 18 is attached to the mounting member 36 via the universal joint 37. As a result, the load transmitted from the lift cylinder 18 to the vehicle body 2 due to the rotational movement of the lift cylinder 18 to the front and rear and to the left and right can be further reduced.

The front surface 342 of the pillar part 34 is inclined toward the front and upward from the vehicle body 2. As a result, the mobility range of the work implement 3 disposed in front of the pillar part 34 can be increased. Consequently, the amount of dirt that can be carried by the work implement 3 during excavation can be increased.

The holding part 35 has a shape that is tapered toward the front. As a result, the load of the supporting member 33 on an attachment part of the vehicle body 2 can be reduced. In other words, the holding part 35 has a shape that becomes thicker toward the rear. As a result, the work implement imaging device 45 can be firmly supported and vibration of the work implement imaging device 45 can be reduced.

### Second Exemplary Embodiment

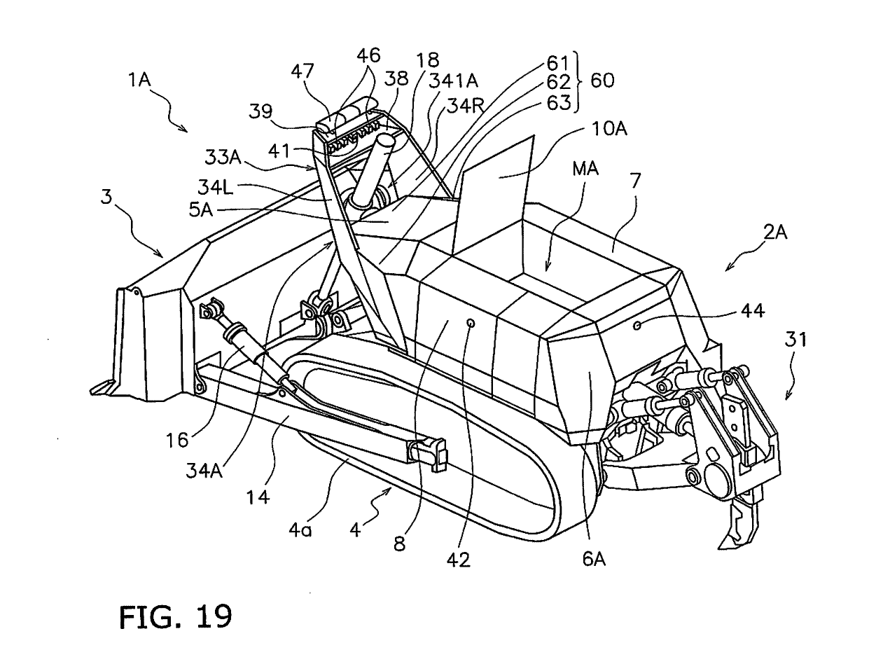

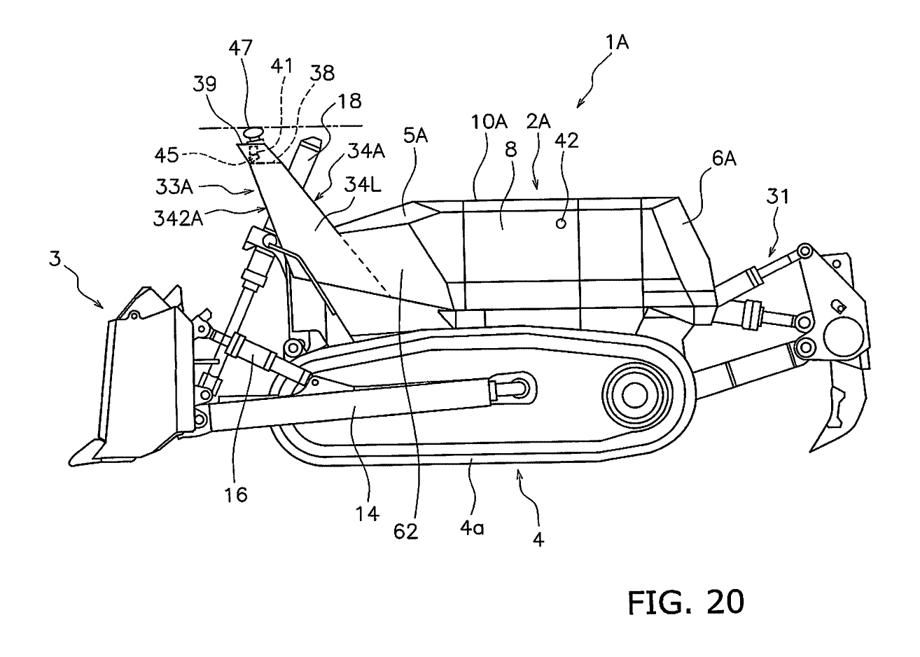

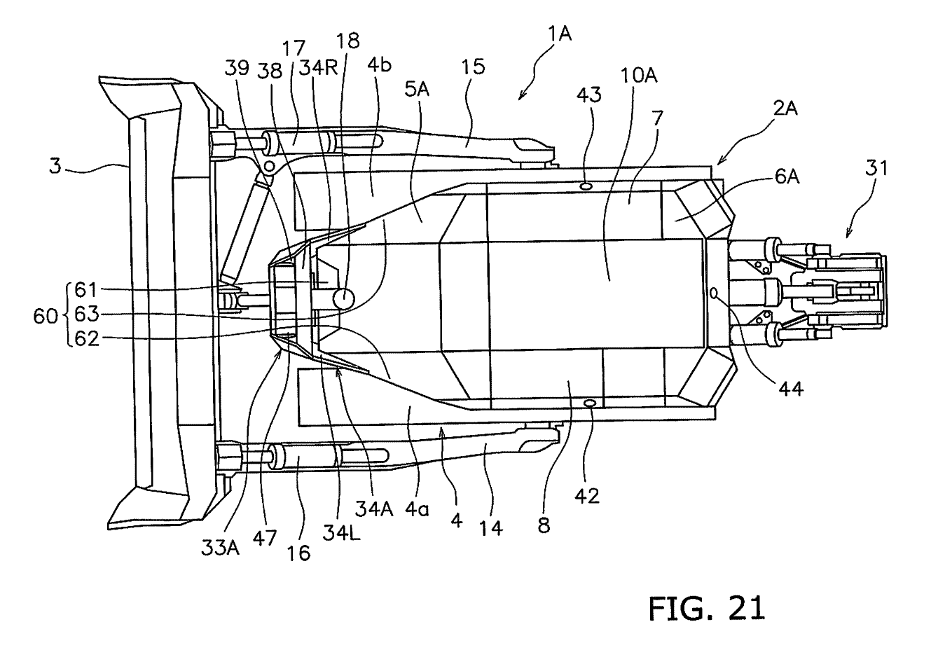

The work vehicle that demonstrates the above effects is not limited to the vehicle according to the first exemplary embodiment. A work vehicle in which the shape of the supporting member 33 in particular is different from that of the first exemplary embodiment will be explained in the second exemplary embodiment. FIG. 19 is a perspective view of a work vehicle 1A according to the second exemplary embodiment. FIG. 20 is a side view of the work vehicle 1A according to the second exemplary embodiment. FIG. 21 is a plan view of the work vehicle 1A according to the second exemplary embodiment. Configurations that are the same as in the first exemplary embodiment will be provided with the same reference numerals and detailed explanations thereof will be omitted in the second exemplary embodiment.

The work vehicle 1A is a bulldozer according to the present exemplary embodiment. The work vehicle 1A is a vehicle that is not provided with an operator's cab. The work vehicle 1A can be operated remotely in the same way as in the first exemplary embodiment. The work vehicle 1A includes a vehicle body 2A and the work implement 3. The vehicle body 2A has an engine compartment 5A instead of the engine compartment 5 of the first exemplary embodiment. The engine compartment 5A differs from the engine compartment 5 of the first embodiment due to the shape of a cladding member 60 that covers the engine compartment 5A. A seen from above, the length in the vehicle width direction of the cladding member 60 decreases further toward the front.

As can be seen in FIG. 21, the cladding member 60 includes a center front part 61, a left side part 62, and a right side part 63. The center front part 61 is a wall part at the front end of the engine compartment 5A. The center front part 61 corresponds to the center part of the vehicle body 2 in the vehicle width direction to which the lift cylinder 18 is attached. The left side part 62 is located to the rear and on the left side of the center front part 61. The left side part 62 is, for example, a left side wall that extends to the rear and to the left from the center front part 61 as seen from above. The right side part 63 is located to the rear and on the right side of the center front part 61. The right side part 63 is, for example, a right side wall that extends to the rear and to the right from the center front part 61 as seen from above. The engine compartment 5A is the same as the engine compartment 5 of the first exemplary embodiment in other points.

The vehicle body 2A has a rear compartment 6A, a right compartment 7, and the left compartment 8. The engine compartment 5A, the rear compartment 6A, the right compartment 7, and the left compartment 8 are disposed so as to surround the maintenance area MA. The engine compartment 5A is disposed in front of the maintenance area MA. The rear compartment 6A is disposed behind the maintenance area MA.

The rear compartment 6A is the fuel tank or is configured to house the fuel tank in the present exemplary embodiment. The rear compartment 6A protrudes further to the rear in comparison to the rear compartment 6 as in the first exemplary embodiment.

A lid member 10A is disposed above the maintenance area MA. The lid member 10A is disposed so as to be able to open and close the maintenance area MA. The lid member 10A is depicted while open in FIG. 1 and the lid member 10A is depicted while closed in FIGS. 2 and 3. The lid member 10A differs from the lid member 10 of the first exemplary embodiment in that the lid member 10A opens upward and toward the front.

In the second exemplary embodiment, the work vehicle 1A further includes a headlight 46 and a rotating lamp 47. The headlight 46, the rotating lamp 47, the front imaging device 41, and the work implement imaging device 45 are attached to a supporting member 33A. The supporting member 33A is attached to a front part of the vehicle body 2A. Specifically, the supporting member 33A is attached to the left side part 62 and the right side part 63. The supporting member 33A is formed from a plate-like member. The supporting member 33A has a left pillar part 34L, a right pillar part 34R, a first beam part 38, and a second beam part 39. The left pillar part 34L and the right pillar part 34R are collectively referred to as a pillar part 34A in the second exemplary embodiment.

The left pillar part 34L and the right pillar part 34R exhibit left-right symmetry. The left pillar part 34L extends upward and toward the front from the left side part 62. The right pillar part 34R extends upward and toward the front from the right side part 63. Specifically, the pillar part 34A extends upward from the vehicle body 2A. A front surface 342A of the left pillar part 34L is inclined toward the front and upward from the vehicle body 2A as can be seen in FIG. 20. The front surface of the right pillar part 34R is inclined in the same way as the left pillar part 34L toward the front and upward from the vehicle body 2A. Specifically, the front surface of the pillar part 34A is inclined toward the front and upward from the vehicle body 2.

The lift cylinder 18 overlaps the left pillar part 34L as seen in a side view of the vehicle. Although not illustrated in the drawings, the lift cylinder 18 overlaps the right pillar part 34R as seen in a side view of the vehicle. That is, the lift cylinder 18 overlaps the pillar part 34A as seen in a side view of the vehicle. The lift cylinder 18 overlaps the supporting member 33A as seen in a side view of the vehicle.

As can be seen in FIG. 21, the left pillar part 34L extends toward the right (in the direction toward the center in the vehicle width direction of the vehicle body 2A) while extending toward the front. The right pillar part 34R extends toward the left (in the direction toward the center in the vehicle width direction of the vehicle body 2A) while extending toward the front. That is, the pillar part 34A extends so as to face toward the center in the vehicle width direction of the vehicle body 2A while extending toward the front. The left pillar part 34L and the right pillar part 34R are bent towards the center in the vehicle width direction of the first beam part 38 at the connecting parts with the first beam part 38. That is, the pillar part 34A is bent towards the center in the vehicle width direction of the first beam part 38 at the connecting parts with the first beam part 38. The left pillar part 34L and the right pillar part 34R both have a shape that is tapered upward. That is, the pillar part 34A has a shape that is tapered upward.

The left pillar part 34L and the right pillar part 34R are disposed on the front side of the engine compartment 5A. That is, the pillar part 34A is disposed on the front side of the engine compartment 5A. The left pillar part 34L and the right pillar part 34R are disposed behind the work implement 3. That is, the pillar part 34A is disposed behind the work implement 3.

The first beam part 38 is connected to the left pillar part 34L and the right pillar part 34R and extends from the left pillar part 34L and the right pillar part 34R inwardly in the vehicle width direction. That is, the first beam part 38 extends in the vehicle width direction from the pillar part 34A. As can be seen in FIG. 19, the supporting member 33A forms a penetrating part 341A due to the left pillar part 34L, the right pillar part 34R, and the first beam part 38. The lift cylinder 18 is disposed through the penetrating part 341A.

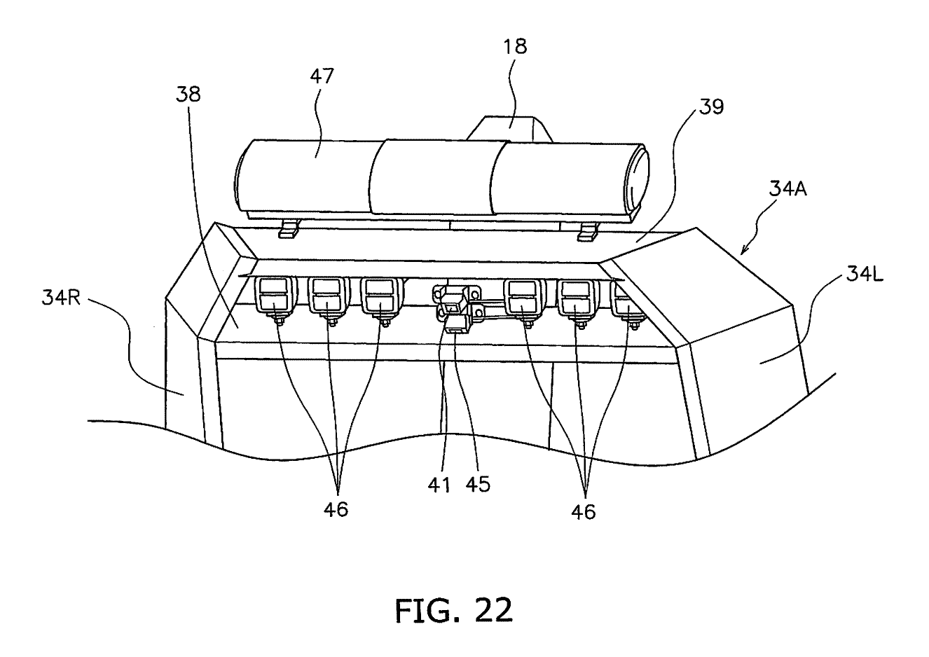

The first beam part 38 is positioned above the work implement 3. The first beam part 38 supports the front imaging device 41, the work implement imaging device 45, and the headlight 46. FIG. 22 is an enlarged perspective view in the vicinity of the upper end of the supporting member 33A according to the second exemplary embodiment. The illustration of the engine compartment 5A behind the supporting member 33A is omitted in FIG. 22. As can be seen in FIG. 22, the front imaging device 41 and the work implement imaging device 45 are disposed in a line vertically in the center in the vehicle width direction of the first beam part 38. Specifically, the work implement imaging device 45 is disposed directly above the first beam part 38 and the front imaging device 41 is disposed directly above the work implement imaging device 45.

The front imaging device 41 may be a camera having a fish-eye lens mounted thereon; however, a camera provided with a lens having a normal angle of view may also be used. The optical axis of the front imaging device 41 is oriented toward the front and slightly downward. The work implement imaging device 45 is a camera including a lens with a normal angle of view. The optical axis of the work implement imaging device 45 is oriented further downward than the optical axis of the front imaging device 41. The work implement imaging device 45 and the front imaging device 41 are disposed in front of the lift cylinder 18.

The headlight 46 is disposed to the side of the front imaging device 41 and the work implement imaging device 45. In the example in FIG. 22, three headlights 46 are disposed on both the left and right of the front imaging device 41 and the work implement imaging device 45; however the number of the headlight 46 is not limited in this way.

The second beam part 39 is connected to the upper ends of the left pillar part 34L and the right pillar part 34R. That is, the second beam part 39 is connected to the upper end of the pillar part 34A. The second beam part 39 extends within the vehicle width direction from the upper ends of the left pillar part 34L and the right pillar part 34R above the first beam part 38. That is, the second beam part 39 extends in the vehicle width direction from the upper end of the pillar part 34A above the first beam part 38. The second beam part 39 supports the rotating lamp 47. The rotating lamp 47 is disposed on the second beam part 39. Therefore, the upper end of the rotating lamp 47 is positioned higher than the upper end of the lift cylinder 18 as can be seen with the chain double-dashed line in FIG. 20. As a result, the rotating lamp 47 is not shielded by the lift cylinder 18. Therefore, the visibility of the rotating lamp 47 is improved.

The lift cylinder 18 is supported in the second exemplary embodiment by the mounting member 36 and the universal joint 37 in the same way as in the first exemplary embodiment. Therefore, the lift cylinder 18 is attached to the center part of the vehicle body 2 in the vehicle width direction. The lift cylinder 18 is attached to the vehicle body 2 while being inclined in the front-back direction of the vehicle body 2.

The control system and the processing and the configurations of the display image of the work vehicle 1A in the second exemplary embodiment are the same as those of the first exemplary embodiment.

The work vehicle 1A according to the second exemplary embodiment as explained above demonstrates the same effects as the work vehicle 1 according to the first exemplary embodiment. That is, the conditions of the surroundings of the work vehicle 1 can also be easily recognized with the display image Is in the work vehicle 1A. In particular, the region in front of the work implement 3 that becomes a blind spot when only using the surroundings imaging device 40 can be captured by the work implement imaging device 45 attached to the first beam part 38 of the supporting member 33A.

Moreover, the lift cylinder 18 is attached to the center part of the vehicle body 2A in the vehicle width direction. As a result, the load from torsion transmitted from the work implement 3 to the vehicle body 2A can be reduced in comparison to when a pair of lift cylinders are disposed away from each other to the left and right.

The operator of the work vehicle 1A is able to recognize the conditions in front of the work implement 3 with the display image Is. As a result, there is no problem with a decrease in forward visibility even if the lift cylinder 18 is attached to the center part of the vehicle body 2A in the vehicle width direction.

Furthermore, the lift cylinder 18 is disposed in the penetrating part 341A of the supporting member 33A. As a result, interference of the lift cylinder 18 on the supporting member 33A is avoided.

The front surface of the pillar part 34A is inclined toward the front and upward from the vehicle body 2A. As a result, the mobility range of the work implement 3 disposed in front of the pillar part 34A can be increased. Consequently, the amount of dirt that can be carried by the work implement 3 during excavation can be increased.

The pillar part 34A has a shape that is tapered upwards. As a result, the load of the supporting member 33A on the attachment parts of the vehicle body 2A can be reduced. In other words, the pillar part 34A has a shape that becomes thicker toward the rear. As a result, the front imaging device 41 and the work implement imaging device 45 can be firmly supported and vibration of the front imaging device 41 and the work implement imaging device 45 can be reduced.

Although exemplary embodiments of the present invention have been described, the present invention is not limited to the above exemplary embodiments and various modifications may be made within the scope of the invention.

The work vehicle is not limited to a bulldozer, and may be another type of work vehicle 1, such as a wheel loader and the like. The work vehicle is not limited to a vehicle that is operated remotely. For example, an operator's cab may be provided on the vehicle body 2 in the same way as a manned work vehicle and a device that is the same as the remote operating device 26 may be provided inside the operator's cab. Consequently, the operator is able to easily operate the work vehicle while viewing the display image.

The method for generating the display image is not limited to the above exemplary embodiments and may be changed. For example, the shapes of the first projection plane A1 and the second projection plane A2 may be changed.

The number of the imaging devices of the surroundings imaging device 40 is not limited to four and may be three or less or five or more. The dispositions of the imaging devices of the surroundings imaging device 40 are not limited to the dispositions indicated in the above exemplary embodiments and may be disposed differently. The imaging devices of the surroundings imaging device 40 are not limited to cameras provided with fish-eye lenses and may be another type of imaging device. The front imaging device 41 may be attached to another part and is not limited to the supporting member 33. For example, the front imaging device 41 may be attached to the vehicle body 2.

The number of the work implement imaging device 45 is not limited to one and may be two or more. The disposition of the work implement imaging device 45 is not limited to the disposition indicated in the above exemplary embodiments and may be disposed differently.

The structures of the supporting members 33 and 33A are not limited to the structures of the above exemplary embodiments and may be changed. For example, the pillar part 34 may be attached to a part other than the mounting member 36. The left pillar part 34L and the right pillar part 34R may be attached to positions further inside instead of the side walls of the engine compartment 5A. The lift cylinder 18 may be attached to the mounting member 36 without the universal joint 37. The shapes of the pillar part 34, the left pillar part 34L, and the right pillar part 34R may be changed. Alternatively, the shapes of the holding part 35, the first beam part 38, and the second beam part 39 may be changed.

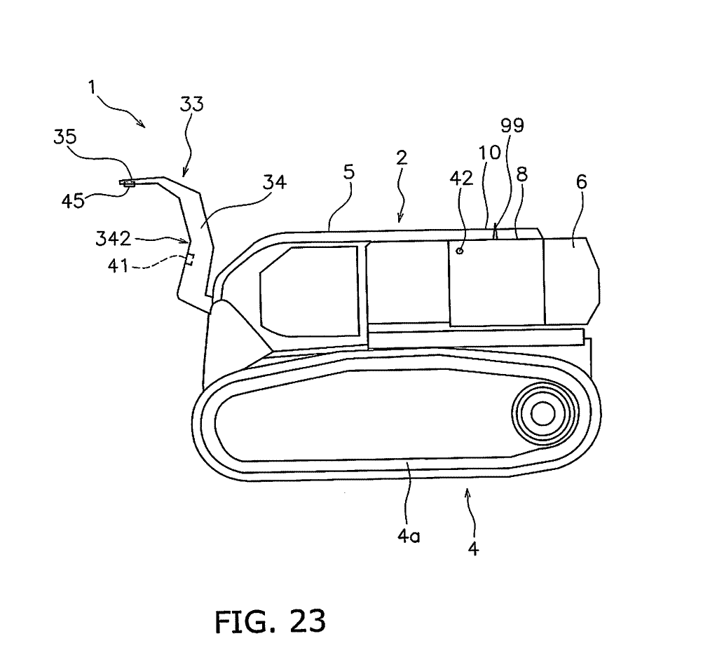

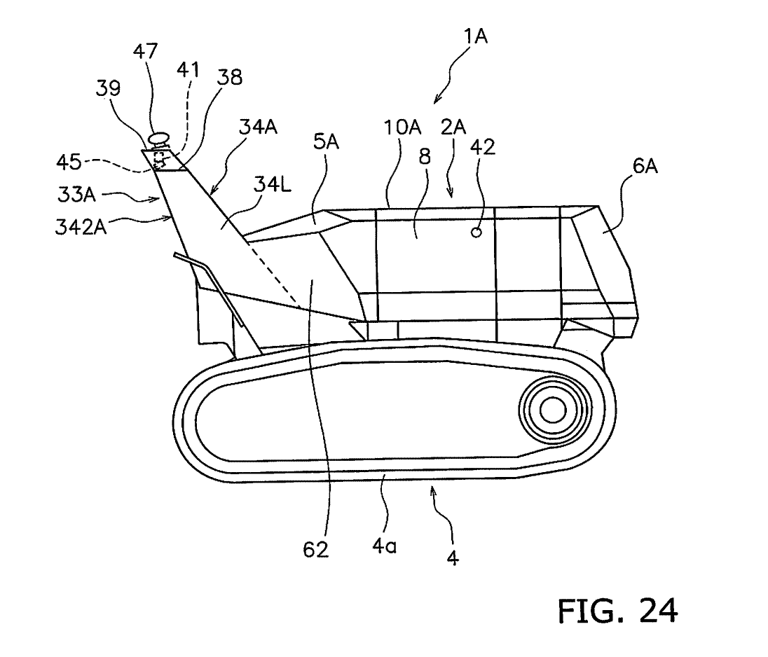

As illustrated in FIG. 23, the work implement 3 (see FIG. 2) may be removed from the work vehicle 1. Moreover, the ripper device 31 (see FIG. 2) may also be removed from the work vehicle 1. Similarly, as illustrated in FIG. 24, the work implement 3 (see FIG. 20) may be removed from the work vehicle 1A. Moreover, the ripper device 31 (see FIG. 20) may also be removed from the work vehicle 1A.

According to the present invention, a work vehicle can be provided in which it is possible to easily recognize the conditions of a region in front of the work vehicle and in which it is possible to improve the balance of the load applied to the vehicle body from the work implement.

1. A work vehicle comprising:
a vehicle body;
a work implement disposed in front of the vehicle body;
a lift cylinder attached to a center part in a vehicle width direction of the vehicle body such that the lift cylinder is inclined in a front-back direction of the vehicle body, the lift cylinder being configured to move the work implement up and down;
a supporting member attached to the center part of the vehicle body in the vehicle width direction, the supporting member extending upward from the vehicle body; and
an imaging device supported by the supporting member, the imaging device being configured to capture an image of a region in front of the vehicle body,
a penetrating part being formed in the supporting member, and
the lift cylinder being disposed through the penetrating part.

2. The work vehicle according to claim 1, wherein
the imaging device has a front imaging device disposed in front of the lift cylinder.

3. The work vehicle according to claim 1, wherein
the supporting member includes
a pillar part extending upward from the vehicle body, and
a holding part extending forward from the pillar part, and
the imaging device has a work implement imaging device supported by the holding part.

4. The work vehicle according to claim 1, wherein
the vehicle body has a mounting member to which the lift cylinder is attached, and
the supporting member is attached to the mounting member.

5. The work vehicle according to claim 4, wherein
the vehicle body has a universal joint supporting the lift cylinder to be rotatable in a front and a rear direction and to be rotatable in a left and a right direction, and
the lift cylinder is attached to the mounting member via the universal joint.

6. The work vehicle according to claim 3, wherein
a front surface of the pillar part is inclined forward and upward from the vehicle body.

7. The work vehicle according to claim 3, wherein
the holding part has a shape that is tapered forward.

8. The work vehicle according to claim 1, wherein
the lift cylinder overlaps the supporting member as seen in a side view of the vehicle.

9. The work vehicle according to claim 1, further comprising
a communication device that communicates with an external remote operating device, the communication device being configured to transmit an image data captured by the imaging device to the remote operating device, and receive an operation signal for operating the work vehicle from the remote operating device; and
a controller configured to control the work vehicle on the basis of the operation signal received from the remote operating device.

10. A work vehicle comprising:
a vehicle body;
a work implement disposed in front of the vehicle body;
a lift cylinder attached to a center part in a vehicle width direction of the vehicle body such that the lift cylinder in a front-back direction of the vehicle body, the lift cylinder being configured to move the work implement up and down;
a supporting member attached to the vehicle body and extending upward from the vehicle body; and
an imaging device supported by the supporting member, the imaging device being configured to capture an image of a region in front of the vehicle body,
the supporting including
a pillar part extending upward from the vehicle body, and
a first beam part extending in the vehicle width direction from the pillar part, and
a penetrating part being formed by the pillar part and the first beam part, and
the lift cylinder being disposed through the penetrating part.

11. The work vehicle according to claim 10, wherein
the imaging device has a front imaging device disposed in front of the lift cylinder.

12. The work vehicle according to claim 10, wherein
the imaging device has a work implement imaging device supported by the first beam part.

13. The work vehicle according to claim 10, wherein
a front surface of the pillar part is inclined forward and upward from the vehicle body.

14. The work vehicle according to claim 10, further comprising
a headlight supported by the first beam part.

15. A work vehicle according to claim 10, further comprising
a rotating lamp,
the supporting member having a second beam part extending in the vehicle width direction from the pillar part above the first beam part, and
the rotating lamp being supported by the second beam part.

16. The work vehicle according to claim 10, wherein
an upper end of the rotating lamp is positioned higher than an upper end of the lift cylinder.

17. The work vehicle according to claim 10, wherein
the lift cylinder overlaps the supporting member as seen in a side view of the vehicle.

18. The work vehicle according to claim 10, wherein
the vehicle body includes
a universal joint supporting the lift cylinder to be rotatable in a front and a rear direction and to be rotatable in a left and a right direction; and
a mounting member to which the lift cylinder is attached via the universal joint.

19. The work vehicle according to claim 10, further comprising
a communication device that communicates with an external remote operating device, the communication device being configured to transmit an image data captured by the imaging device to the remote operating device, and receive an operation signal for operating the work vehicle from the remote operating device; and
a controller configured to control the work vehicle on the basis of the operation signal received from the remote operating device.
